(19) United States
(12) Patent Application Publication
(10) Pub. No.: US 2005/0106073 A1
(43) Pub. Date: May 19, 2005

(54) Sample holder for a reactor, reactor and method for producing the sample holder

(76) Inventor: Hans-Richard Kretschmer, Berlin (DE)

Correspondence Address: YOUNG & THOMPSON, 745 SOUTH 23RD STREET, 2ND FLOOR, ARLINGTON, VA, 22202, US

(21) Appl. No.: 10/784,998

(22) Filed: Feb. 25, 2004

(30) Foreign Application Priority Data
Feb. 25, 2003 (DE) 10309201.3

(51) Int. Cl. B01J 19/00

(52) U.S. Cl. 422/102; 422/130

(57) ABSTRACT

A sample holder has inserts, which are arranged in apertures of the sample holder, so that electrical contacting can take place from the side facing away from the samples. Electrical leads to the individual sample regions can be provided from the opposite side of the sample holder, allowing greater production tolerances to be accepted. The sample holder may also be exchangeably accommodated in a reactor for subjecting the sample holder to a sample fluid, so that the reactor can be used for different sample holders. In this case, the electrical contacting of the contact locations takes place by corresponding counter contacts in a sample holder compartment provided for the sample holder.

### BACKGROUND OF THE INVENTION

The invention relates to a sample holder for installation in a reaction chamber intended for a sample fluid, with a holder plate made of an electrically insulating material, on one side of which electrically conductive receiving regions for sample constituents of the sample fluid that are to be detected are located, the receiving regions being assigned electrical contact locations.

Such a sample holder installed in a reactor is described in the U.S. patent with the U.S. Pat. No. 6,245,508 B1. The sample holder described has a holder plate, on one side of which square contact locations, including the electrical leads leading to these contact locations, are produced from a coating by structuring. On the contact locations there is in each case a further layer, which prevents direct contact of the sample constituents that are to be detected with the contact regions. On the last-mentioned layer, a layer of interaction partners is respectively immobilized, serving for the attachment of the sample constituents that are to be detected. The layers of interaction partners consequently serve as receiving regions for the sample constituents that are to be detected.

### SUMMARY OF THE INVENTION

The object of the invention is to provide a sample holder having receiving regions for samples and electrical contact locations assigned to the latter, which can be produced and handled comparatively easily.

This object is achieved according to the invention by the electrical contact locations being located on the other side of the holder plate, facing away from the receiving regions, and the holder plate being provided with apertures through which the electrical contact locations are electrically connected to the receiving regions. Consequently, the electrical leads for the contact locations are led through the apertures from one side of the holder plate to the other side, so that the entire surface area of the other side is available for accommodating contact locations and leads. This makes the production of the sample holder considerably easier, since greater tolerances can be accepted, in particular in the production of the leads. Furthermore, the receiving regions can be arranged more advantageously next to one another with a smaller spacing on one side of the sample holder, which permits a high degree of miniaturization of the sample holder.

Accommodating contact locations on the other side of the sample plate also makes it easier to handle. For example, the sample plate can be inserted in a simple way into a receiving compartment provided for this purpose, in which counter contacts are provided for the contact locations.

According to an advantageous embodiment of the invention, it is provided that inserts which bear the receiving regions on their one side and are electrically connected to the electrical contact locations with their other side are located in the apertures. The inserts may consist for example of an electrically conducting plastic and be pressed into the apertures. A material which is well suited for immobilizing interaction partners, such as oligonucleotides for example, may be advantageously used for the inserts, these interaction partners being in connection with the receiving regions of the inserts. The inserts are particularly advantageously suitable for producing an electrically conductive connection in the apertures with little technical expenditure, allowing the receiving regions and the electrical contact locations to be electrically connected to one another.

According to a further refinement of the invention, the inserts pass through the holder plate and form the electrical contact locations on the other side of the latter. As a result, there is no longer any need for the electrical contact locations to be separately produced, since the inserts themselves are produced from an electrically conductive material. This advantageously allows the expenditure involved in the production of the sample holder to be reduced further.

According to another refinement of the invention, it is provided that the inserts are convexly curved on their one side. The one side consequently forms convexly curved receiving regions, which are particularly well suited for immobilizing interaction partners such as oligonucleotides. The attachment of the sample constituents that are to be detected, for example by a hybridization reaction, is promoted by the curved surface of the receiving regions. This effect has long been known in connection with the use of spherical so-called beads for the attachment of sample constituents that are to be detected.

It is advantageous if the inserts respectively have a single convexly curved surface area, which extends in the manner of a spherical cap over the entire receiving region. As a result, the surface of a single bead is advantageously replicated by means of the inserts. It is also advantageous if the inserts respectively have a multiplicity of convexly curved surface areas, which extend in the manner of facets over the entire receiving region. In this case, the insert replicates a surface such as that which a multiplicity of beads arranged next to one another would be capable of producing. In this respect, the radius of curvature may be advantageously chosen independently of the dimensions of the insert such-that it is optimal for an effective attachment of interaction partners or sample constituents. It is also advantageous if the radius of curvature of the convexly curved surface areas is between 20 and 500 μm. As a result, dimensions customary for beads are replicated.

According to another refinement of the invention, a reference electrode is attached on the one side of the holder plate. This reference electrode may be advantageously used in a potentiometric investigation of sample constituents located on the receiving region. The corresponding receiving region in this case forms the working electrode for the potentiometric measurement, while a counter electrode may also be provided next to the reference electrode. By attaching the reference electrode on the one side of the holder plate, the latter can be advantageously brought up very close to the receiving regions serving as a working electrode. This has a positive effect on the accuracy of the difference in potential established between the working electrode and the reference electrode. The attachment of the reference electrode on the one side of the holder plate is only possible because the electrical contact locations for the leads to the receiving regions lie on the other side of the holder plate.

The invention also relates to a reactor for a sample fluid with a reaction chamber, in which a sample holder in plate form is located, on one side of which electrically conductive receiving regions for sample constituents of the sample fluid that are to be detected are located, the receiving regions being assigned electrical contact locations.

Such a reactor is described in the U.S. patent specification already mentioned at the beginning with the U.S. Pat. No. 6,245,508 B1. The reactor described has a reaction chamber which can be filled with a sample fluid. Permanently installed in the interior of the reaction chamber is a sample holder in plate form, on one side of which receiving regions for sample constituents are located in the form of the already mentioned layer of interaction partners for the attachment of the sample constituents. Each of the receiving regions is assigned a contact location, which respectively has an electrical lead, which leads out from the interior of the reaction chamber.

The object of the invention is to provide a reactor which is comparatively easy to produce and handle for a sample fluid, with an electrically contacted sample holder.

This object is achieved according to the invention by the sample holder being exchangeably arranged in a sample holder compartment, which is located in the reaction chamber and has terminal contacts for the electrical contact locations. The exchangeability of the sample holder ensures that the reaction chamber of the reactor can be used for different sample holders one after the other, in that they are exchanged in the sample chamber by means of easily implemented handling steps. In this case, the sample holder itself may be of a very simple construction, since it is automatically connected by a connection of the contact locations in the sample holder compartment via leads located in the reactor to the terminals for reading out the electrical variables. Furthermore, the reactor is advantageously particularly inexpensive to use, since the reaction chamber only-has to be produced once and can subsequently be used for a multiplicity of different sample holders that can be produced very easily.

According to a refinement of the invention, a self-supporting electrode grid aligned parallel to one side of the sample holder is arranged in the reaction chamber as a reference electrode. This achieves the effect that the sample holder can be advantageously produced without a reference electrode, so that the production of the sample holder is made even easier. The reference electrode is formed as part of the reaction chamber, so that it is not exchanged along with the sample holder but is available for the investigation of the different sample holders.

Another refinement of the invention provides that a wall part of the reaction chamber is aligned parallel to one side of the sample holder, bearing the receiving regions, and on the wall part counter electrodes are respectively arranged opposite the receiving regions. These counter electrodes then form with the respective receiving regions a pair of electrodes which is suitable for example for the potentiometric evaluation of the processes occurring at the receiving regions. It is particularly advantageous in this case to use a reference electrode of a potential which can be taken as a basis for the potentiometric measurements.

Furthermore, the invention relates to a method for producing a sample holder for installation in a reaction chamber intended for a sample fluid, in which electrically conductive receiving regions for sample constituents of the sample fluid that are to be detected are produced on one side of a holder plate made of an electrically insulating material and the receiving regions are assigned electrical contact locations for electrical contacting.

Such a method is clearly evident from the construction of the sample holder already described at the beginning according to the U.S. patent specification with the U.S. Pat. No. 6,245,508 B1.

The object of the invention is to provide a method for producing a sample holder having electrically conductive receiving regions, with which the sample holder can be produced comparatively easily.

This object is achieved according to the invention by making apertures in the holder plate, forming inserts bearing the receiving regions in the apertures and producing the electrical contact locations on the other side of the holder plate, facing away from the receiving regions, and connecting them to the inserts. As already explained, this achieves the advantage that the conductive paths leading to the contact locations can be provided on the rear side of the holder plate, whereby the front side of the holder plate can be used for the receiving regions alone. In this case, greater production tolerances can be advantageously accepted, making production of the sample holder easier.

According to a further refinement of the method, the apertures are produced in the holder plate, which consists in particular of silicon, by an etching treatment. It is consequently advantageously possible to rely on a tried-and-tested micromechanical production technology. With the etching treatment, highly accurate production is possible, even of miniaturized apertures. In particular, anisotropic etching can be performed on both sides of the holder plate, allowing apertures having the form of two pyramids penetrating at the tips to be produced.

Another refinement of the method provides that the inserts are produced in the apertures by injection molding, in particular of polycarbonate containing graphite, the apertures serving as part of the injection mold. Therefore, this advantageously concerns a mounting injection-molding process, whereby the connection between the inserts and the holder plate can advantageously be made particularly secure. In particular, inserts which have undercuts of a form corresponding to the formation of the apertures can be produced, since the inserts only solidify when they are in the apertures.

In order to produce the already mentioned convex surfaces of the inserts, one side of the holder plate, the side bearing the receiving regions, may be brought together with a mold plate in which the convex structure of the inserts is formed as a negative structure. In this way, the injection mold is completed as it were, so that injection of the polycarbonate can take place from the other side of the holder plate. Once the inserts have solidified, the mold plate is removed again, the solidified inserts remaining in the holder plate. The mold plate may consist of silicon for example, allowing the negative forms of the concave surface areas of the inserts to be advantageously produced with great accuracy in the surface of the silicon. This can be achieved for example by an etching treatment.

### BRIEF DESCRIPTION OF THE DRAWINGS

Further details of the invention are explained below on the basis of the drawing, in which:

FIG. 1 shows a sectionally represented detail of an exemplary embodiment of the sample holder according to the invention and

FIG. 2 schematically shows, in section, an exemplary embodiment of a reactor with an installed exchangeable sample holder.

### DESCRIPTION OF THE PREFERRED EMBODIMENTS

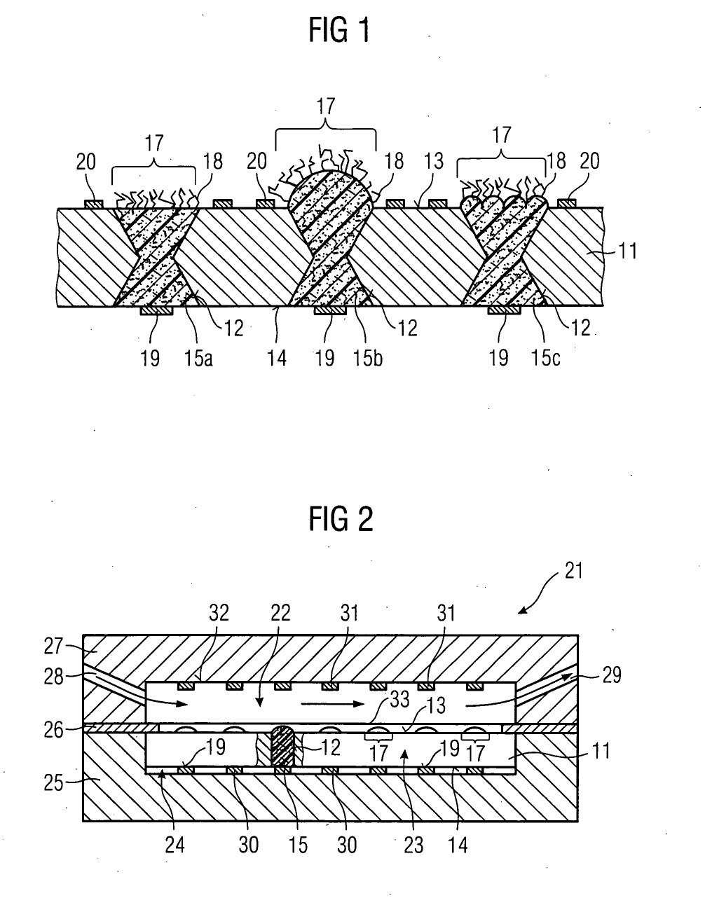

A sample holder according to FIG. 1 comprises a holder plate 11, which is provided by means of an anisotropic etching process with apertures 12, which connect the one side 13 to the other side 14 of the holder plate. Injection-molded in these apertures 12 are inserts 15a, 15b, 15c, which consist of electrically conductive plastic containing graphite.

The inserts 15a, 15b and 15c bear on the one side receiving regions 17 for receiving sample constituents that are to be detected (not represented). For this purpose, oligonucleotides 18 are immobilized on the receiving regions 17 as interaction partners for DNA sequences that are to be detected as sample constituents. The receiving regions 17 are located on the one side 13 of the holder plate 11. Located on the other side 14 of the holder plate, at the corresponding other end of the inserts 15a, 15b 15c, are electrical contact locations 19, which permit a connection of the respective inserts 15a, 15b and 15c, for example for an electrical investigation of the sample constituents on the receiving regions 17. For this purpose, on the other side 14 electrical leads (not represented any more specifically), which can be produced for example from a conductive coating of the holder plate 11 using known masking technology, may be led to the contact locations 19.

On the one side 13 of the holder plate 11, a reference electrode 20 has been applied as a structured coating, the reference electrode surrounding in an annular manner the reference regions 17 formed by the inserts 15a, 15b 15c. The reference electrode may be used for example to obtain results that are comparable with one another in a potentiometric investigation of the sample constituents attached on the receiving regions 17. Also necessary for a potentiometric evaluation is a counter electrode (not represented in FIG. 1), the receiving regions respectively forming the working electrode.

Represented in FIG. 2 is a reactor 21 with a reaction chamber 22, into which a sample holder 23, constructed in a way similar to the sample holder according to FIG. 1, has been installed into a sample holder compartment 24. The sample holder compartment 24 forms a lower shell 25 of the reactor, the sample holder 23 being held in the sample holder compartment 24 by means of a closure plate 26. Provided in an upper shell 27 are an inlet 28 and an outlet 29 for the sample fluid, which flows through the reaction chamber 22 in a way corresponding to the arrows indicated.

The electrical contact locations 19 of the sample holder 23 are contacted by means of terminal contacts 30 in the sample holder compartment 24. The terminal contacts 30 are connected in a way not represented any more specifically to electrical leads, which are led out from the reactor 21, in order for example to permit reading out from the receiving regions 17 of the sample holder acting as working electrodes. Opposite the receiving regions 17, counter electrodes 31 are accommodated in a wall part 32 of the reaction chamber 22 running parallel to the sample holder 23, in such a way that a counter electrode 31 in each case respectively lies opposite a receiving region 17. An electrode grid 33, which is accommodated in a self-supporting manner in the reaction chamber 22, running along at a small distance from the one side 13 of the sample holder and parallel to this side, is provided in the reaction chamber as the reference electrode. This may be produced for example by a coating and structuring of a substrate forming the upper shell 27 of the reactor. In this case, the closure plate 26 determines by its thickness the distance of the electrode grid 33 from the one side 13 of the sample holder.

The receiving regions 17 of the sample holder 23 are formed in a manner in the form of a spherical cap (see the receiving region 17 of insert 15b). Further possible geometrical forms of the receiving regions 17 can be taken from FIG. 1. The insert 15a has a planar receiving region, which lies in the plane of the one side 13. The receiving region 17 of the insert 15b has a single curvature, extending over the entire receiving region. This curvature is formed in the manner of a spherical cap if the insert has a circular cross section. If the insert has a square cross section (this is the case if the apertures 12 are produced by anisotropic etching in the silicon), the receiving region is formed in its concave curvature in a manner similar to an inflated cushion. The receiving region 17 of the insert 15c has a multiplicity of convexly curved surface areas, which are arranged in the manner of facets alongside one another in rows and in this way extend over the entire receiving region 17.

1-14. (canceled)

15. A sample holder for installation in a reaction chamber (22) intended for detecting sample constituents of a sample fluid, comprising:
a holder plate (11) made of an electrically insulating material;
electrically conductive receiving regions (17) located on one side of the holder plate, the receiving regions configured for holding sample constituents of a sample fluid;
electrical contact locations (19) assigned to corresponding ones of the receiving regions and located on the other side of the holder plate, the electrical contact locations facing away from the corresponding receiving regions; and
apertures provided through the plate, via which apertures the contact locations are electrically connected with the corresponding receiving regions.

16. The sample holder of claim 15, further comprising:
inserts (15a, 15b, 15c) located in the apertures,
the receiving regions mounted on the inserts on the one side of the holder plate, and
the inserts electrically connecting the receiving regions and the contact locations.

17. The sample holder of claim 16, wherein,
the inserts pass through the apertures, and
the contact locations are mounted on the inserts on the other side of the holder plate.

18. The sample holder of claim 16, wherein,
the inserts, on the one side of the holder plate, have an exterior surface convexly curved.

19. The sample holder of claim 18, wherein,
the inserts (15b) have a single convexly curved exterior surface area extending as a spherical cap corresponding to an entire receiving region.

20. The sample holder of claim 18, wherein,
the inserts (15c) comprise plural convexly curved surface areas extending as facets over an entire receiving region.

21. The same holder of claim 19, wherein,
a radius of curvature of the convexly curved surface area is between 20 and 500 μm.

22. The same holder of claim 20, wherein,
a radius of curvature of each of the convexly curved surface areas is between 20 and 500 μm.

23. The sample holder of claim 15, further comprising:
a reference electrode (20) attached on the one side of the holder plate.

24. The sample holder of claim 23, wherein the reference electrode annularly surrounds each of the receiving regions.

25. A reactor for a sample fluid having sample constituents and exchangeably holding a sample holder (23) with electrically conductive receiving regions (17) located on one side of the sample holder, the receiving regions configured for holding sample constituents of a sample fluid, and electrical contact locations (19) assigned to each of the receiving regions and located on the other side of the sample holder, the reactor comprising:
a reaction chamber (22);
an interior sample holder compartment (24) to support the sample holder within the reaction chamber; and
terminal contacts (30) located on one surface of the sample holder compartment, the terminal contacts being positioned for electrical contact with the electrical contact locations of the sample holder.

26. The reactor of claim 25, further comprising:
a reference electrode in the form of a self-supporting electrode grid (33) positioned for parallel alignment with the supported sample holder on the one side of the sample holder.

27. The reactor of claim 26, wherein,
the reaction chamber comprising a wall part (32) aligned parallel to the one side of the supported sample holder,
the wall part bearing mounting counter electrodes (31), and
the counter electrodes being positioned to be in alignment with the receiving regions of the supported sample holder.

28. A method of producing a sample holder for installation in a reaction chamber (22) intended for detecting sample constituents of a sample fluid, comprising the steps of:
forming apertures (12) in a holder plate;
within the apertures, forming inserts (15a, 15b, 15c) with electrically conductive receiving regions (17) for holding the sample constituents, the receiving regions being located on a first ends of the inserts and on one side of the holder plate; and
providing electrical contact locations (19) on second ends of the inserts and on the other side of the holder plate, the receiving regions being electrically connected to the electrical contact locations via the inserts.

29. The method of claim 28, wherein,
the holder plate comprises silicon, and
the apertures are formed by etching of the holder plate.

30. The method of claim 28, wherein,
the inserts are formed in the apertures by injection molding.

31. The method of claim 30, wherein,
the inserts comprise injected polycarbonate containing graphite, and
the apertures serve as a part of an injection mold in injection molding the inserts.

32. The method of claim 28, further comprising the step of immobilizing oligonucleotides on the electrically conductive receiving regions.

33. The sample holder of claim 15, further comprising:
oligonucleotide immobilized on the electrically conductive receiving regions.

34. The sample holder of claim 16, wherein, the inserts have a narrowed mid-region at approximately a horizontal centerline of the holder plate.
